(19) United States
(12) Patent Application Publication
(10) Pub. No.: US 2025/0214023 A1
(43) Pub. Date: Jul. 3, 2025

(54) ORGANIC SOLVENT RECOVERY SYSTEM

(71) Applicant: TOYOBO MC Corporation, Osaka-shi, Osaka (JP)

(72) Inventors: Takemasa Okada, Otsu-shi, Shiga (JP); Kazuyuki Ono, Osaka-shi, Osaka (JP); Daiki Kohno, Osaka-shi, Osaka (JP)

(73) Assignee: TOYOBO MC Corporation, Osaka-shi, Osaka (JP)

(21) Appl. No.: 18/848,673

(22) PCT Filed: Mar. 24, 2023
(86) PCT No.: PCT/JP2023/011944

§ 371 Date: Sep. 19, 2024

(30) Foreign Application Priority Data
Mar. 31, 2022 (JP) 2022-060476

(51) Int. Cl. B01D 53/04; B01J 20/20; B01J 20/34

(52) U.S. Cl. CPC B01D 53/0407; B01J 20/20; B01J 20/3416; B01J 20/3466; B01D 2253/102; B01D 2259/4009

(57) ABSTRACT

An organic solvent recovery system of the present invention includes: an organic solvent recovery device that includes a first adsorbing material, and further includes at least three treatment tanks that alternately perform an adsorption treatment of adsorbing the organic solvent and of discharging a first treated gas, a desorption treatment of desorbing the organic solvent and of discharging a desorbed gas, and a drying treatment of drying the first adsorbing material and of discharging a dry outlet gas; an organic solvent concentration device that includes a second adsorbing material, adsorbs the organic solvent from the first treated gas, discharges a second treated gas, desorbs the organic solvent with a desorbing gas, and discharges the organic solvent as a concentrated gas; and a return flow path that returns the concentrated gas.

### TECHNICAL FIELD

The present invention relates to an organic solvent recovery system.

### BACKGROUND ART

Conventionally, a system that recovers an organic solvent from a gas containing the organic solvent has been known. For example, PTL 1 discloses an organic solvent recovery system that includes: an organic solvent recovery device that includes two adsorption columns; and a backup treatment device that adsorbs an organic solvent contained in a treated gas discharged from any of treatment tanks of the organic solvent recovery device.

Each adsorption column includes an adsorbing material (activated carbon fibers etc.) that can adsorb the organic solvent contained in an organic-solvent-containing gas. In each adsorption column, an adsorption step, and a desorption step using water vapor are alternately performed. The backup treatment device includes an adsorbing material that can adsorb the organic solvent contained in the treated gas discharged from the adsorption column.

The backup treatment device has a zone for applying a treatment of adsorbing the organic solvent contained in the treated gas with the adsorbing material, and a zone for applying a treatment of desorbing the organic solvent adsorbed in the adsorbing material, from the adsorbing material. A desorbed gas with the organic solvent having been desorbed from the adsorbing material is returned to the organic-solvent-containing gas that is to be supplied to each adsorption column of the organic solvent recovery device.

### CITATION LIST

### Patent Literature

PTL 1: Japanese Patent Laying-Open No. H9-308814

### SUMMARY OF INVENTION

### Technical Problem

In the organic solvent recovery system in PTL 1, the adsorption step is executed in the adsorbing material of the organic solvent recovery device, and subsequently, the adsorption step is further executed with the adsorbing material of the backup treatment device, thereby improving the organic solvent removal rate. However, there is a need to improve the organic solvent removal rate of the organic solvent recovery system.

In the case of the organic solvent recovery system in PTL 1, the adsorption column of the organic solvent recovery system immediately after the desorption step is in a state of being filled with high-temperature water vapor. When the desorption step is switched to the adsorption step, the treated gas that is at a high temperature and has a high dew-point temperature is discharged from the adsorption column, and is subsequently supplied to the backup treatment device. Accordingly, the adsorption efficiency of the backup treatment device decreases, and a sufficient removal rate cannot be achieved.

Furthermore, since the adsorbing material of the organic solvent recovery device is highly moisturized after the desorption step, there will be a continuing state in which the dew-point temperature of the treated gas continuously discharged from the adsorption column during the adsorption step is higher than the dew-point temperature of the organic-solvent-containing gas supplied to the adsorption column. Accordingly, the adsorption efficiency of the adsorbing material of the backup treatment device further decreases, and a sufficient removal rate cannot be achieved.

When the dew-point temperature of the treated gas supplied to the backup treatment device is high, much of the moisture in the treated gas is adsorbed by the adsorbing material of the backup treatment device. The moisture adsorbed by the adsorbing material of the backup treatment device is desorbed by the desorption treatment. Accordingly, the desorbed gas of the backup treatment device also has a high dew-point temperature. As a result, the humidity of the organic-solvent-containing gas to which the desorbed gas is returned greatly increases, the adsorption efficiency of the adsorbing material of the organic solvent recovery device decreases, and a sufficient removal rate cannot be achieved.

Because of these reasons, as humidity of the treated gas increases, it is necessary to design each adsorption column and the backup treatment device with larger adsorbing materials accordingly. Consequently, there is a problem of requiring a large amount of energy for operation.

Accordingly, an object of the present invention, which has been made in view of the problems described above, is to provide an organic solvent recovery system that can reduce the operation energy of the entire facility when the organic solvent removal rate is improved.

### Solution to Problem

An organic solvent recovery system of the present invention includes:
an organic solvent recovery device that includes a first adsorbing material capable of adsorbing and desorbing an organic solvent, and further includes at least three treatment tanks that alternately perform an adsorption treatment of adsorbing the organic solvent with the first adsorbing material from an introduced gas to be treated containing the organic solvent and of discharging a first treated gas, a desorption treatment of desorbing the organic solvent from the first adsorbing material with introduced water vapor and of discharging a desorbed gas, and a drying treatment of drying the first adsorbing material with an introduced drying gas and of discharging a dry outlet gas;
a water vapor supplier that introduces the water vapor into the treatment tank selected from among the treatment tanks;
a gas-to-be-treated supply flow channel that introduces the gas to be treated into the treatment tank selected from among the treatment tanks;
a drying gas supply flow channel that supplies the drying gas to the treatment tank selected from among the treatment tanks;
an organic solvent concentration device that includes a second adsorbing material capable of adsorbing and desorbing the organic solvent, adsorbs, with the second adsorbing material, the organic solvent from the first treated gas discharged from the organic solvent recovery device, discharges a second treated gas, desorbs the organic solvent from the second adsorbing material with a desorbing gas, and discharges the organic solvent as a concentrated gas; and
a return flow path that returns the concentrated gas discharged from the organic solvent concentration device to the gas-to-be-treated supply flow channel.

In addition to the configuration described above, the present invention may further include a temperature adjuster that adjusts the drying gas to a prescribed temperature, on the drying gas supply flow channel.

In addition to the configuration described above, the present invention may further include a cooling element and a heating element that adjust a temperature and a humidity of the gas to be treated in prescribed ranges, at an upstream portion of the gas-to-be-treated supply flow channel.

### Advantageous Effects of Invention

According to the present invention, an organic solvent recovery system can be provided that can reduce the operation energy of the entire facility when the organic solvent recovery rate is improved.

### BRIEF DESCRIPTION OF DRAWING

FIG. 1 is a diagram schematically shows an organic solvent recovery system of Embodiment 1.

### DESCRIPTION OF EMBODIMENT

An organic solvent recovery system of each embodiment based on this disclosure is hereinafter described with reference to the drawing. In the embodiment described below, in a case of referring to the number and quantities of items, the scope of this disclosure is not limited to the number and quantities and the like, unless otherwise specified. The identical components and equivalent components are assigned the same reference numerals, and redundant description is not repeated in some cases. Appropriate combination and use of components in the embodiment are originally assumed.

### Embodiment

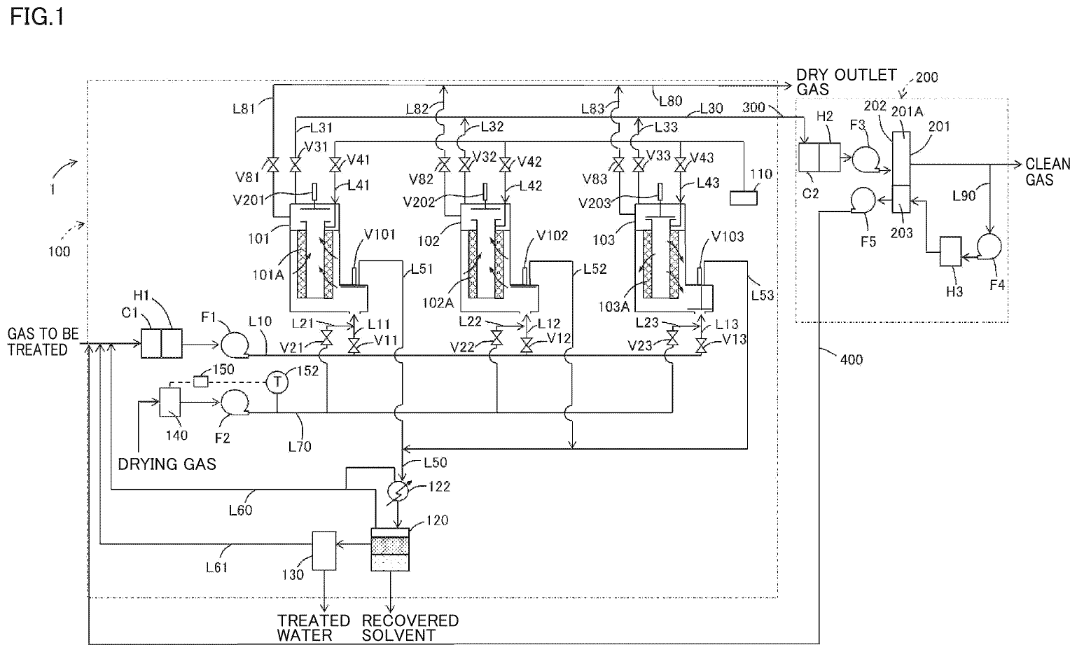

FIG. 1 is a diagram schematically shows an organic solvent recovery system of Embodiment 1. As shown in FIG. 1, an organic solvent recovery system 1 includes an organic solvent recovery device 100, an organic solvent concentration device 200, a feed flow channel 300, and a return flow channel 400. Organic solvent recovery system 1 causes organic solvent recovery device 100 to remove and recover an organic solvent from a gas to be treated that contains the organic solvent. This system subsequently causes organic solvent concentration device 200 to further remove and concentrate the organic solvent from a first treated gas discharged from organic solvent recovery device 100, and returns a concentrated gas discharged from organic solvent concentration device 200, to a gas-to-be-treated supply flow channel L4 of organic solvent recovery device 100 through return flow channel 400.

The organic solvent that is a treatment target of organic solvent recovery system 1 indicates methylene chloride, chloroform, carbon tetrachloride, ethylene chloride, trichloroethylene, tetrachloroethylene, O-dichlorobenzene, m-dichlorobenzene, Freon-112, Freon-113, HCFC, HFC, propyl bromide, butyl iodide, methyl acetate, ethyl acetate, propyl acetate, butyl acetate, vinyl acetate, methyl propionate, methyl acrylate, ethyl acrylate, butyl acrylate, methyl methacrylate, diethyl carbonate, ethyl formate, diethyl ether, dipropyl ether, tetrahydrofuran, dibutyl ether, anisole, methanol, ethanol, isopropanol, n-butanol, 2-butanol, isobutanol, t-butanol, allyl alcohol, pentanol, heptanol, ethylene glycol, diethylene glycol, phenol, O-cresol, m-cresol, p-cresol, xylenol, acetone, methyl ethyl ketone, methyl isobutyl ketone, cyclohexanone, holon, acrylonitrile, n-hexane, isohexane, cyclohexane, methylcyclohexane, n-heptane, n-octane, n-nonane, isononane, decane, dodecane, undecane, tetradecane, decalin, benzene, toluene, m-xylene, p-xylene, o-xylene, ethylbenzene, 1,3,5-trimethylbenzene, N-methylpyrrolidone, dimethylformamide, dimethylacetamide, dimethylsulfoxide, etc. However, these are not limitation.

Organic solvent recovery device 100 is a facility that removes and recovers the organic solvent from the gas to be treated.

The gas to be treated is supplied to organic solvent recovery device 100 from a gas-to-be-treated supply source (not shown) provided outside of the system of organic solvent recovery device 100. Organic solvent recovery device 100 includes three treatment tanks 101 to 103, a gas-to-be-treated supply flow channel L10, extraction flow channels L31 to L33, water vapor supply flow channels L41 to L43, a drying gas supply flow channel L70, dry outlet gas extraction flow channels L81 to L83, organic solvent recovery flow channels L51 to L53, a separator 120, a resupply flow channel L60, a temperature adjuster 140, and a controller 150.

Treatment tanks 101 to 103 respectively include first adsorbing materials 101A to 103A that can adsorb an organic solvent and desorb the organic solvent. While adsorbing materials 101A to 103A may be any of granular activated carbon, honeycomb activated carbon, zeolite, and activated carbon fibers, it is preferable that those made of activated carbon fibers be used. Treatment tanks 101 to 103 respectively include: on-off dampers V101 to V103 that switch between supply and non-supply of the gas to be treated to gas-to-be-treated supply ports; and on-off dampers V201 to V203 that switch between discharge and non-discharge of treated gas discharge ports after passage through first adsorbing materials 101A to 103A.

In treatment tanks 101 to 103, adsorption of the organic solvent by first adsorbing materials 101A to 103A, desorption of the organic solvent from first adsorbing materials 101A to 103A, and desiccation of first adsorbing materials 101A to 103A are alternately performed. The details are as follows. In one treatment tank among three treatment tanks 101 to 103, an adsorption step of adsorbing the organic solvent by the first adsorbing material from the gas to be treated supplied from the gas-to-be-treated supply source is performed. Meanwhile, in another treatment tank among three treatment tanks 101 to 103, a desorption step of desorbing the organic solvent from the first adsorbing material is performed. Meanwhile, in the remaining treatment tank, a drying step of drying the first adsorbing material by the drying gas supplied from drying gas supply flow channel L70 is performed. In each of treatment tanks 101 to 103, the adsorption step, the desorption step, the drying step, and the adsorption step are repetitively performed in this order. Referring to FIG. 1, description is performed assuming that the adsorption step is performed in first treatment tank 101, the desorption step is performed in second treatment tank 102, and the drying step is performed in third treatment tank 103.

Gas-to-be-treated supply flow channel L10 is a flow channel for supplying the gas to be treated to treatment tanks 101 to 103. An upstream end of gas-to-be-treated supply flow channel L10 is connected to the gas-to-be-treated supply source. Gas-to-be-treated supply flow channel L10 is provided with an air blower F1. On the upstream side of air blower F1 on gas-to-be-treated supply flow channel L10, a cooler C1, as a cooling element, and a heater H1, as a heating element, which adjust the temperature and humidity of the gas to be treated flowing into treatment tanks 101 to 103 within prescribed ranges, are provided. Such equipment may be appropriately installed depending on the pressing force, temperature, and humidity of the gas to be treated.

Gas-to-be-treated supply flow channel L10 includes branched flow channels L11 to L13 for supplying the gas to be treated respectively to treatment tanks 101 to 103. Branched flow channel L11 is provided with an on-off valve V11.

Branched flow channel L12 is provided with an on-off valve V12. Branched flow channel L13 is provided with an on-off valve V13.

Extraction flow channels L31 to L33 are flow channels for extracting a first treated gas that is the gas to be treated having been subjected to the adsorption treatment in treatment tanks 101 to 103. Extraction flow channels L31 to L33 are connected to treated gas discharge ports at respective treatment tanks 101 to 103. First extraction flow channel L31 is provided with an on-off valve V31. Second extraction flow channel L32 is provided with an on-off valve V32. Third extraction flow channel L33 is provided with an on-off valve V33. Extraction flow channels L31 to L33 include a combined flow channel L30 where they converge.

Water vapor supply flow channels L41 to L43 are flow channels for respectively supplying treatment tanks 101 to 103 with water vapor for desorbing the organic solvent adsorbed in first adsorbing materials 101A to 103A, from first adsorbing materials 101A to 103A. Water vapor is supplied from a water vapor supplier 110. Water vapor supplier 110 may be provided in organic solvent recovery device 100, or outside of the system of organic solvent recovery device 100.

First water vapor supply flow channel L41 connects water vapor supplier 110 and a first treatment tank 101. First water vapor supply flow channel L41 is provided with an on-off valve V41. Second water vapor supply flow channel L42 connects water vapor supplier 110 and a second treatment tank 102. Second water vapor supply flow channel L42 is provided with an on-off valve V42. Third water vapor supply flow channel L43 connects water vapor supplier 110 and a third treatment tank 103. Third water vapor supply flow channel L43 is provided with an on-off valve V43.

Drying gas supply flow channel L70 is a flow channel for supplying branched flow channels L21 to L23 with the drying gas for promoting drying first adsorbing materials 101A to 103A immediately after the desorption. An upstream end of drying gas supply flow channel L70 is connected to a drying gas supply source. The drying gas is made up of a gas that contains at least one of the outside air, instrument air, nitrogen gas, and argon gas. Drying gas supply flow channel L70 is provided with an air blower F2. At a part of drying gas supply flow channel L70 that is upstream of air blower F2, temperature adjuster 140 that adjusts the temperature of the drying gas flowing into treatment tanks 101 to 103 within a prescribed range is provided. Temperature adjuster 140 heats the drying gas so that the temperature of the drying gas can be a temperature (about 40 to 70° C.) sufficient for drying first adsorbing materials 101A to 103A.

The temperature of the drying gas used in the drying step is detected by a temperature sensor 152. Temperature sensor 152 is provided on drying gas supply flow channel L70.

Controller 150 controls the drying gas temperature. Specifically. Controller 150 performs control of temperature adjuster 140 so that the drying gas temperature detected by temperature sensor 152 can be maintained at about 40 to 70° C., which is a prescribed range.

Drying gas supply flow channel L70 includes branched flow channels L21 to L23 for supplying the drying gas respectively to treatment tanks 101 to 103. Branched flow channel L21 is provided with an on-off valve V21.

Branched flow channel L22 is provided with an on-off valve V22. Branched flow channel L23 is provided with an on-off valve V23.

Dry outlet gas extraction flow channels L81 to L83 are flow channels for extracting the dry outlet gas that is the drying gas after application of the drying treatment to first adsorbing materials 101A to 103A of treatment tanks 101 to 103. Dry outlet gas extraction flow channels L81 to L83 are connected to treated gas discharge ports at respective treatment tanks 101 to 103. First dry outlet gas extraction flow channel L81 is provided with an on-off valve V81. Second dry outlet gas extraction flow channel L82 is provided with an on-off valve V82. Third dry outlet gas extraction flow channel L83 is provided with an on-off valve V83. Dry outlet gas extraction flow channels L81 to L83 include a dry outlet gas extraction flow channel L80 where they converge. The dry outlet gas is discharged to the outside of the system of organic solvent recovery device 100 through this dry outlet gas extraction flow channel L80.

Organic solvent recovery flow channels L51 to L53 are flow channels for recovering water vapor (desorbed gas) containing the organic solvent desorbed from first adsorbing materials 101A to 103A. Organic solvent recovery flow channels L51 to L53 are connected to treatment tanks 101 to 103 respectively. Organic solvent recovery flow channels L51 to L53 include a combined flow channel L50 where they converge. Combined flow channel L50 is provided with a condenser 122. Condenser 122 condenses the desorbed gas flowing through combined flow channel L50, by cooling the desorbed gas, and discharges the condensate (a mixture of moisture generated by condensing the desorbed gas, and the liquid-phase organic solvent).

Separator 120 is provided at a downstream end of combined flow channel L50. The condensate flows into separator 120. Subsequently, in separator 120, the condensate undergoes phase separation into the liquid-phase separated drainage (condensate of water vapor sometimes containing a small amount of organic solvent), and the liquid-phase recovered solvent, and the recovered solvent is extracted to the outside of the system of organic solvent recovery device 100. A space (vent gas) in which the gas-phase organic solvent resides is formed in an upper part of separator 120.

Resupply flow channel L60 is a flow channel that connects separator 120, condenser 122, and gas-to-be-treated supply flow channel L10. An upstream end of resupply flow channel L60 is connected to an upper part of separator 120 (a part where a gas-phase organic solvent resides in separator 120), and an upper part of condenser 122 (a part where a gas-phase organic solvent resides in condenser 122). A downstream end of resupply flow channel L60 is connected to a part of gas-to-be-treated supply flow channel L10 that is upstream of cooler C1. Accordingly, it is preferable that the gas-phase organic solvent residing in separator 120 and condenser 122 be resupplied to treatment tanks 101 to 103 through resupply flow channel L60 and gas-to-be-treated supply flow channel L10.

A drainage treatment facility 130 is a facility that removes the organic solvent contained in the separated drainage. The liquid-phase separated drainage of separator 120 is supplied, the organic solvent is removed from the separated drainage, and the treated water is discharged to the outside of the system of organic solvent recovery device 100. Specific drainage treatment facility 130 may be an aeration facility that applies an aeration treatment to the separated drainage, and vaporizes the organic solvent contained in the separated drainage accordingly, thus achieving separation between an aeration gas containing the organic solvent, and treated water. The aeration gas is introduced to the part of gas-to-be-treated supply flow channel L10 that is upstream of cooler C1 via an aeration gas supply flow channel L61. Although not shown, the aeration gas supply flow channel may be provided with dehumidification means for the sake of removing moisture from the aeration gas.

Next, organic solvent concentration device 200 is described. Organic solvent concentration device 200 is a facility that further removes the organic solvent from the first treated gas discharged from organic solvent recovery device 100. Organic solvent concentration device 200 includes an adsorber 201.

Adsorber 201 includes second adsorbing materials 201A that can adsorb the organic solvent contained in the first treated gas discharged through combined flow channel L30. Adsorber 201 includes: an adsorbent 202 that adsorbs the organic solvent contained in the first treated gas by second adsorbing materials 201A; and a desorbent 203 that desorbs the organic solvent adsorbed in second adsorbing materials 201A from second adsorbing materials 201A. By causing the first treated gas to pass through adsorbent 202, the second treated gas that is a clean gas with the organic solvent having further been removed can be discharged, and after completion of the adsorption, a heated gas at a lower air flow rate than the first treated gas is caused to pass through desorbent 203, and the organic solvent adsorbed in second adsorbing materials 201A is desorbed, thereby allowing a concentrated gas where the organic solvent is concentrated to be discharged.

In the present embodiment, adsorber 201 is a disk-shaped (disc-shaped) rotor. Adsorber 201 rotates between adsorbent 202 and desorbent 203, thereby switching between adsorption and desorption. The structure of adsorber 201 is similar to that in the description in PTL 1. Note that adsorber 201 may be formed to have a cylindrical shape. In cylindrical-shaped adsorber 201, plurality of second adsorbing materials 201A divided into blocks are disposed in a cylindrical manner. In adsorber 201, some of second adsorbing materials 201A constitute adsorbent 202 that adsorbs the organic solvent contained in the first treated gas supplied from the outside to inside of second adsorbing materials 201A, and remaining second adsorbing materials 201A constitute desorbent 203 that desorbs the organic solvent adsorbed in second adsorbing materials 201A from second adsorbing materials 201A by supplying the heated air from the inside to outside of second adsorbing materials 201A.

Feed flow channel 300 is a flow channel for feeding the gas to be treated from organic solvent recovery device 100 to organic solvent concentration device 200. An upstream end of feed flow channel 300 is connected to combined flow channel L30. A downstream end of feed flow channel 300 is connected to adsorbent 202 of adsorber 201. That is, feed flow channel 300 is a flow channel for feeding the first treated gas to adsorbent 202.

Feed flow channel 300 is provided with an air blower F3. At parts of feed flow channel 300 that are upstream of air blower F3, a cooler C2, as a cooling element, and a heater H2, as a heating element, which adjust the temperature and humidity of the first treated gas flowing into adsorbent 202 within prescribed ranges, are provided.

Return flow channel 400 is a flow channel for returning the concentrated gas from organic solvent concentration device 200 to organic solvent recovery device 100. Return flow channel 400 connects desorbent 203 and gas-to-be-treated supply flow channel L10. Specifically, a downstream end of return flow channel 400 is connected to a part of gas-to-be-treated supply flow channel L10 that is upstream of cooler C1.

Return flow channel 400 is provided with an air blower F5. The air flow rate of air blower F5 is set to, for example, about one tenth of the air flow rate of air blower F3.

In the present embodiment, organic solvent concentration device 200 feeds the clean gas that is the second treated gas discharged from adsorbent 202, from clean gas discharge flow channel L202 to the outside. Organic solvent concentration device 200 further includes connecting flow channel L90, and a heater H3.

Connecting flow channel L90 connects clean gas discharge flow channel L202 and desorbent 203, and allows part of the second treated gas to be used as a desorbing gas that is to be used for desorption in desorbent 203. Connecting flow channel L90 is provided with an air blower F4. A configuration of using the outside air for desorption in desorbent 203 may be adopted instead.

Heater H3 as a heating element is provided on connecting flow channel L90. More specifically, heater H3 is provided at a part of connecting flow channel L90 that is downstream of air blower F4. For example, heater H3 heats the second treated gas flowing through connecting flow channel L90 so that the temperature of the second treated gas can be at about 130° C. to 180° C. In this case, the temperature of the second treated gas discharged from desorbent 203 is about 50° C. to 80° C.

Next, the operation of organic solvent recovery system 1 is described. Here, referring to FIG. 1, an example of the operation of organic solvent recovery system 1 is described. Referring to FIG. 1, description is performed assuming the flow of the gas in a state in which the adsorption step is performed in first treatment tank 101, the desorption step is performed in second treatment tank 102, and the drying step is performed in third treatment tank 103.

Note that in each treatment tank, the treatment is repeated in the order of the adsorption step→the desorption step→the drying step→the adsorption step . . . .

In the assumed state described above, on-off valves V11, V23, V31, V42, and V83, and on-off dampers V101, V103, V201, and V203 are open, and on-off valves V12, V13, V21, V22, V32, V33, V41, V43, V81, and V82, and on-off dampers V102, and V202 are closed.

From the gas-to-be-treated supply source, through gas-to-be-treated supply flow channel L10 and branched flow channel L11, the gas to be treated is supplied to first treatment tank 101, and the organic solvent contained in the gas to be treated is adsorbed in first adsorbing material 101A of first treatment tank 101 (adsorption step). Subsequently, the first treated gas that is the gas to be treated discharged from first treatment tank 101 is fed to adsorber 201 of organic solvent concentration device 200 through first extraction flow channel L31 and feed flow channel 300, and the organic solvent contained in the first treated gas is adsorbed in adsorbent 202.

Next, the second treated gas discharged from adsorbent 202 is extracted to the outside of organic solvent recovery system 1, and part of the gas is fed to desorbent 203 through connecting flow channel L90. At this time, the second treated gas fed to desorbent 203 is heated by heater H3. The concentrated gas discharged from desorbent 203 is returned to gas-to-be-treated supply flow channel L10 of organic solvent recovery device 100 through return flow channel 400.

Water vapor is supplied to one second treatment tank 102 from water vapor supplier 110 through second water vapor supply flow channel L42, thereby desorbing the organic solvent from first adsorbing material 102A (desorption step). The water vapor containing the organic solvent desorbed from first adsorbing material 102A passes through organic solvent recovery flow channel L52, is condensed by condenser 122, and subsequently flows into separator 120. The recovered solvent phase-separated by separator 120 is extracted to the outside of the system of organic solvent recovery device 100. The vent gas residing in condenser 122 and separator 120 is returned to gas-to-be-treated supply flow channel L10 through resupply flow channel L60. The separated drainage is treated by drainage treatment facility 130. The treated water is extracted to the outside of the system of organic solvent recovery device 100. The aeration gas is returned to gas-to-be-treated supply flow channel L10 through aeration gas supply flow channel L61.

Furthermore, the drying gas is supplied to one second treatment tank 102 from the drying gas supply source through drying gas supply flow channel L70 and branched flow channel L23, thus drying first adsorbing material 103A of third treatment tank 103 (drying step). Since the drying step is executed after the desorption step using water vapor, first adsorbing material 103A contains much moisture, and requires desiccation for improving the adsorption performance. Subsequently, the dry outlet gas that is the drying gas discharged from third treatment tank 103 is discharged to the outside of the system of organic solvent recovery device 100 through dry outlet gas extraction flow channel L83 and dry outlet gas extraction flow channel L80.

As described above, in organic solvent recovery system 1 of the present embodiment, the dry outlet containing much moisture discharged from third adsorbing material 103A is discharged to the outside of the system. Accordingly, in the subsequent adsorption step, the dew-point temperature of the first treated gas discharged from third treatment tank 103 can be kept low. Although the inside of third treatment tank 103 immediately after the desorption step is at a high temperature of 100° C. or more, it is cooled to a prescribed temperature (about 40 to 70° C.) immediately after the drying step. Thus, in the subsequent adsorption step, the temperature of the first treated gas discharged from third treatment tank 103 can be kept low. That is, the temperature and the dew-point temperature of the first treated gas supplied to second adsorbing materials 201A of organic solvent concentration device 200 can be kept low, the adsorption efficiencies of second adsorbing materials 201A can be improved, and the concentration of the organic solvent contained in the second treated gas discharged from organic solvent concentration device 200 can be significantly reduced. As a result. the organic solvent removal rate of solvent recovery system 1 can be improved.

Since the dew-point temperature of the first treated gas supplied to second adsorbing materials 201A of organic solvent concentration device 200 can be kept low, the amount of water adsorbed by adsorbent 202 of each second adsorbing material 201A can be significantly reduced. As a result, the dew-point temperature of the concentrated gas discharged from desorbent 203 can also be reduced, and the dew-point temperature of the gas to be treated after the concentrated gas passes through return flow channel 400 and converges can be reduced. As a result, the adsorption efficiency of first adsorbing material 101A of first treatment tank 101 of organic solvent recovery device 100 can be improved, and the organic solvent removal rate of organic solvent recovery device 100 can be improved.

According to these results, the removal rate of the organic solvent in both organic solvent recovery device 100 and organic solvent concentration device 200 is improved, which can avoid increase in the size of the entire facility.

Note that the embodiment disclosed here is an example in all respects, and is not restrictive. The scope of the present invention is indicated by the claims instead of the description of the aforementioned embodiment, and further encompasses meanings equivalent to the claims, and all the changes in the scope.

The following treatment was executed using aforementioned organic solvent recovery system 1 shown in FIG. 1. A gas containing an organic solvent as a gas to be treated was a gas to be treated that contains 27,000 ppm of methylene chloride at 25° C. with an air flow rate of 1.9 Nm³/min.

First, the gas to be treated was treated in organic solvent recovery device 100. Activated carbon fibers were used as the first adsorbing material. The concentrated gas of the organic solvent concentration device converged to the gas to be treated, and was blown by air blower F1 with an air flow rate of 2.2 Nm³/min to first treatment tank 101 that was in the adsorption step. Subsequently, the first treated gas discharged from first treatment tank 101 was blown to organic solvent concentration device 200 through feed flow channel 300.

At the time when the methylene chloride concentration of the first treated gas discharged from first treatment tank 101 reached 300 ppm, the step was switched. While first treatment tank 101 was performing the adsorption step, the vapor for desorption was introduced into the second treatment tank, in which the desorption step was performed, and the drying gas was introduced into the third treatment tank, in which the drying step was performed. The drying gas was adjusted to be at 3.3 Nm³/min and 50° C.

Honeycomb zeolite was used as second adsorbing materials 201A of organic solvent concentration device 200. Part of the first treated gas discharged from organic solvent recovery device 100 was supplied through connecting flow channel L90, heated to 130° C., and supplied to desorbent 203, and the concentrated gas was discharged. The total amount of concentrated gas was supplied to gas-to-be-treated supply flow channel L10 of organic solvent recovery device 100 through return flow channel 400.

At this time, the methylene chloride concentration of the second treated gas (gas discharged to the outside of the organic solvent recovery system) was 5 ppm or less.

Note that the activated carbon fibers used as the first adsorbing material of organic solvent recovery device 100 was 4.2 kg/tank, the amount of water vapor required for one time of desorption was 2.1 kg, and zeolite used as second adsorbing materials 201A of organic solvent concentration device 200 was 2 kg.

### Comparative Example

Similar to the embodiment, the same gas to be treated as that in the embodiment was treated by the organic solvent recovery device and organic solvent concentration device 200. Note that the organic solvent recovery device in the comparative example included two treatment tanks, but included neither drying gas supply flow channel L70 nor dry outlet gas extraction flow channel L80. In the organic solvent recovery device in the comparative example, while one treatment tank was performing the adsorption step, the other treatment tank was performing desorption step. In each treatment tank, the treatment was repeated in the order of the adsorption step→the desorption step→the adsorption step . . . .

As a result, the activated carbon fibers used as the first adsorbing materials of organic solvent recovery device 100 when the methylene chloride concentration of the second treated gas was 5 ppm or less was 5.0 kg/tank, the amount of water vapor required for one time of desorption was 2.5 kg, zeolite used as second adsorbing materials 201A of organic solvent concentration device 200 was 2.6 kg, and the amount of water vapor to be used was increased by about 20% compared to the embodiment.

As described above, it can be seen that to allow the comparative example to have the same treatment capacity as the embodiment, the comparative example is required to have an increased operation energy. That is, it can be seen that in the embodiment, the organic solvent recovery rate can be improved while avoiding increase in operation energy.

### REFERENCE SIGNS LIST

1 Organic solvent recovery system
100 Organic solvent recovery device
101 First treatment tank
101A First adsorbing material
102 Second treatment tank
102A First adsorbing material
103 Third treatment tank
103A First adsorbing material
110 Water vapor supplier
120 Separator
130 Drainage treatment facility
140 Temperature adjuster
150 Controller
152 Temperature sensor
200 Organic solvent concentration device
201 Adsorber
201A Second adsorbing material
202 Adsorbent
203 Desorbent
300 Feed flow channel
400 Return flow channel
L10 Gas-to-be-treated supply flow channel
L21, L22, L23 Branched flow channel
L31, L32, L33 Extraction flow channel
L41, L42, L43 Water vapor supply flow channel
L51, L52, L53 Organic solvent recovery flow channel
L60 Resupply flow channel
L70 Drying gas supply flow channel
L80 Dry outlet gas extraction flow channel
L81, L82, L83 Dry outlet gas extraction flow channel
L90 Connecting flow channel
V11, V12, V13, V21, V22, V23, V31, V32, V33, V41, V42, V43, V81, V82, V83 On-off valve
V101, V102, V103, V201, V202, V203 On-off damper

1. An organic solvent recovery system, comprising:
an organic solvent recovery device that includes a first adsorbing material capable of adsorbing and desorbing an organic solvent, and further includes at least three treatment tanks that alternately perform an adsorption treatment of adsorbing the organic solvent with the first adsorbing material from an introduced gas to be treated containing the organic solvent and of discharging a first treated gas, a desorption treatment of desorbing the organic solvent from the first adsorbing material with introduced water vapor and of discharging a desorbed gas, and a drying treatment of drying the first adsorbing material with an introduced drying gas and of discharging a dry outlet gas;
a water vapor supplier that introduces the water vapor into the treatment tank selected from among the treatment tanks;
a gas-to-be-treated supply flow channel that introduces the gas to be treated into the treatment tank selected from among the treatment tanks;
a drying gas supply flow channel that supplies the drying gas to the treatment tank selected from among the treatment tanks;
an organic solvent concentration device that includes a second adsorbing material capable of adsorbing and desorbing the organic solvent, adsorbs, with the second adsorbing material, the organic solvent from the first treated gas discharged from the organic solvent recovery device, discharges a second treated gas, desorbs the organic solvent from the second adsorbing material with a desorbing gas, and discharges the organic solvent as a concentrated gas; and
a return flow path that returns the concentrated gas discharged from the organic solvent concentration device to the gas-to-be-treated supply flow channel.

2. The organic solvent recovery system according to claim 1, further comprising
a temperature adjuster that adjusts the drying gas to a prescribed temperature, on the drying gas supply flow channel.

3. The organic solvent recovery system according to claim 1, further comprising a cooling element and a heating element that adjust a temperature and a humidity of the gas to be treated in prescribed ranges, at an upstream portion of the gas-to-be-treated supply flow channel.
